(19) United States
(12) Patent Application Publication
(10) Pub. No.: US 2026/0088395 A1
(43) Pub. Date: Mar. 26, 2026

(54) BATTERY PACK AND ENERGY STORAGE SYSTEM INCLUDING THE SAME

(71) Applicant: LG ENERGY SOLUTION, LTD., Seoul (KR)

(72) Inventors: Hong-Jae PARK, Daejeon (KR); Yo-Hwan KIM, Daejeon (KR); Se-Hwan LIM, Daejeon (KR)

(73) Assignee: LG ENERGY SOLUTION, LTD., Seoul (KR)

(21) Appl. No.: 19/336,045

(22) Filed: Sep. 22, 2025

(30) Foreign Application Priority Data
Sep. 23, 2024 (KR) 10-2024-0128182
Jul. 31, 2025 (KR) 10-2025-0105371

(51) Int. Cl. H01M 10/6568; B60L 50/60; H01M 10/613; H01M 10/625; H01M 10/627; H01M 10/647; H01M 50/211; H01M 50/249; H01M 50/251; H01M 50/30

(52) U.S. Cl. CPC H01M 10/6568; B60L 50/60; H01M 10/613; H01M 10/625; H01M 10/627; H01M 10/647; H01M 50/211; H01M 50/249; H01M 50/251; H01M 50/30; H01M 2200/20; H01M 2220/10; H01M 2220/20

(57) ABSTRACT

A battery pack includes a plurality of battery cells; and a pack case having an accommodation space in which the plurality of battery cells are accommodated. In the pack case, a cooling passage and at least one communication hole are formed. The cooling passage is configured to allow a cooling medium to flow. The communication hole is configured to allow the cooling passage to communicate with the accommodation space, so that the cooling medium may be directly injected from the cooling passage to the accommodation space.

### CROSS-REFERENCE TO RELATED APPLICATIONS

This application is based on and claims priority from Korean Patent Application No. 10-2024-0128182 filed on Sep. 23, 2024 and No. 10-2025-0105371 filed on Jul. 31, 2025, with the Korean Intellectual Property Office, the disclosure of which is incorporated herein in its entirety by reference.

### TECHNICAL FIELD

The present disclosure relates to a battery pack and an energy storage system including the same.

### BACKGROUND

Secondary batteries, which have high applicability depending on product groups and have electrical properties such as high energy density, are being used widely not only for portable devices but also for electric vehicles (EVs), hybrid electric vehicles (HEVs), energy storage systems (ESSs), and the like. These secondary batteries are attracting attention as a new energy source for eco-friendly and energy efficiency improvement not only because there is a primary advantage in that the use of fossil fuels can be drastically decreased but also because there are no by-products generated by the use of the energy.

Depending on the charging/discharging capacity of a battery pack required for electric vehicles, hybrid vehicles or energy storage systems, a large number of battery cells may be connected in series or parallel to configure the battery pack. Here, in a general method, a battery module including at least one battery cell is first configured, and then a battery pack or a battery rack is configured by using at least one battery module and adding other components. Alternatively, a cell to pack-type battery pack has also been manufactured recently in which a plurality of battery cells is directly housed in a pack housing, and the like, rather than being modularized.

Meanwhile, as the usage range of secondary batteries expands in this manner, safety issues accompanying the expanded use of secondary batteries are emerging as important issues.

### SUMMARY

The present disclosure provides a battery pack capable of ensuring efficient cooling performance, safety or reliability of battery cells, and an energy storage system including the same.

However, the present disclosure are not limited to the above-described features, and other unmentioned features will be clearly understood by those skilled in the art from the description of the invention described below.

The present disclosure provides a battery pack including a plurality of battery cells; and a pack case having an accommodation space in which the plurality of battery cells is accommodated. In the pack case, a cooling passage and at least one communication hole are formed. The cooling passage is configured to allow a cooling medium to flow. The communication hole is configured to allow the cooling passage to communicate with the accommodation space.

The cooling passage may be formed in a hollow shape at least partially in the inner space of the pack case.

The pack case may include a bottom plate having a configuration in which the plurality of battery cells is seated, and having an inner space in which the cooling passage is formed.

The cooling passage may be formed along the periphery of the bottom plate.

The cooling passage may include a first passage and a second passage formed on both sides of the pack case, respectively.

The cooling passage may include a connecting passage that is provided outside the pack case and is configured to connect the first passage to the second passage.

The pack case may include an inlet port and a discharge port. The inlet port is configured to allow the cooling medium to flow into the cooling passage, and the discharge port is configured to allow the cooling medium to be discharged to the outside of the pack case.

The inlet port and the discharge port may be provided on the same side surface of the pack case.

One end of the cooling passage may be configured to be opened, and the other end of the cooling passage may be configured to be closed.

A plurality of communication holes may be provided and may be disposed along a direction in which the cooling passage extends.

The cross-sectional areas of the communication holes may be at least partially differentially configured.

The pack case may include a venting portion on one side surface. The venting portion is configured to discharge venting gas, and the like, generated from the battery cells, to the outside.

The battery pack according to one embodiment of the present disclosure may further include a cover member that covers the venting portion. The cover member is configured to open the venting portion when the internal pressure of the pack case has reached a specific pressure.

The energy storage system according to the present disclosure may include the battery pack according to the present disclosure.

The vehicle according to the present disclosure may include the battery pack according to the present disclosure.

The present disclosure provides a pack case including a bottom plate and a top plate. The bottom plate has an accommodation space in which a plurality of battery cells is accommodated. The top plate is coupled to the bottom plate and is provided to cover the top side of the plurality of battery cells accommodated in the accommodation space. Meanwhile, in the bottom plate, a cooling passage is formed such that a cooling medium is allowed to flow along the periphery of the bottom surface.

In the cooling passage, at least one communication hole is formed. The communication hole is configured to allow the cooling medium to be injected into the accommodation space from the cooling passage.

A plurality of communication holes is formed in the cooling passage, and the respective cross-sectional areas of the communication holes are at least partially differentially configured.

According to one aspect of the present disclosure, a non-conductive fluid may be brought into direct contact with the battery cells, thereby efficiently cooling the battery cells. This may improve the cooling performance of the battery pack.

According to one aspect of the present disclosure, since a pipe, a fan, and the like, for cooling are unnecessary, it is possible to efficiently use the internal space of the battery pack. Accordingly, the energy efficiency of the battery pack may be improved.

According to one aspect of the present disclosure, in an abnormal situation of the battery cells, since it is possible to quickly respond to thermal runaway, the safety and reliability of the battery pack may be ensured.

According to one aspect of the present disclosure, venting gas generated in an abnormal situation of the battery cells is smoothly discharged to the outside of the pack case, thereby effectively ensuring pack-level thermal propagation prevention performance.

According to one aspect of the present disclosure, heat accumulation inside the pack case may be prevented, and thus other battery cells may be prevented from being thermally damaged as much as possible.

According to one aspect of the present disclosure, flame generation in the battery pack may be prevented or suppressed.

Thus, through this configuration, it is possible to prevent or delay events caused by a thermal runaway phenomenon in battery packs or devices equipped with these, for example, fire, explosion, and the like.

In addition, the present disclosure may have several other effects, which will be described in each embodiment. Meanwhile, the relevant explanation will be omitted for effects that may be easily inferred by those skilled in the art.

### BRIEF DESCRIPTION OF THE DRAWINGS

The following drawings attached hereto illustrate embodiments of the present disclosure and serve to further understand the technical idea of the present disclosure together with the content of the disclosure described above. Therefore, the present disclosure should not be construed as being limited to the matters illustrated in the drawings.

FIG. 1 is an overall perspective view of a battery pack according to one embodiment of the present disclosure.

FIG. 2 is an exploded perspective view of the battery pack according to one embodiment of the present disclosure.

FIG. 3 is a cross-sectional view of the battery pack according to one embodiment of the present disclosure, and for example, FIG. 3 may be a drawing illustrating a cross-section taken along I-I′ of FIG. 1.

FIG. 4 is a cross-sectional view of the battery pack according to one embodiment of the present disclosure, and for example, FIG. 4 may be a drawing illustrating a cross-section taken along II-II′ of FIG. 1.

FIG. 5 is a rear perspective view of the battery pack according to one embodiment of the present disclosure.

FIG. 6 is a view illustrating a front view of the battery pack according to one embodiment of the present disclosure.

FIG. 7 is a front perspective view of the battery pack according to one embodiment of the present disclosure.

FIG. 8 is a front perspective view of the battery pack according to one embodiment of the present disclosure, in which a portion of the configuration is disassembled.

FIG. 9 is a perspective view of a main portion of the battery pack according to one embodiment of the present disclosure, in an enlarged scale.

FIG. 10 is a top view of the interior of the battery pack according to one embodiment of the present disclosure.

FIG. 11 is a rear perspective view of the battery pack according to one embodiment of the present disclosure, in which a portion of the configuration is disassembled.

FIG. 12 is a cross-sectional view of the battery pack according to one embodiment of the present disclosure. and for example, FIG. 12 may be a drawing illustrating a portion of the rear side of a cross-section taken along III-III′ of FIG. 1.

FIG. 13 is a cross-sectional view in a case where a thermal event has occurred in the battery pack according to one embodiment of the present disclosure.

FIG. 14 is a view illustrating an energy storage system and a vehicle, which include the battery packs according to one embodiment of the present disclosure.

Corresponding reference characters indicate corresponding components throughout the several views of the drawings. The drawing figures presented are illustrated for simplicity and clarity and have not necessarily been drawn to scale. For example, the dimensions of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments.

### DETAILED DESCRIPTION

Hereinafter, embodiments of the present disclosure will be described in detail with reference to accompanying drawings. Prior to this, terms or words used in the present specification and claims should not be limitedly construed as usual or dictionary meanings, and should be interpreted as meanings and concepts consistent with the technical idea of the present disclosure on the basis of the principle that the inventor can appropriately define the concept of the term in order to explain his/her own invention in the best way.

Therefore, the embodiments described in this specification and the configurations illustrated in drawings are merely some examples of the present disclosure, and do not represent all of technical ideas of the present disclosure. Thus, it should be understood that there may be various equivalents and modifications that can replace them at the time of filing this application.

In addition, the present disclosure includes various embodiments. In the individual embodiments, duplicate descriptions of substantially identical or similar components will be omitted, and explanations will be focused on differences.

Meanwhile, although terms indicating directions such as up, down, left, right, front, and back may be used in the present disclosure, it is obvious to those skilled in the art of the present disclosure that these terms are only for convenience of explanation and may vary depending on the location of a target object, the location of an observer, and the like.

For example, in the embodiment of the present disclosure, the X-axis direction, the Y-axis direction, and the Z-axis direction depicted in the drawings may mean the left-right direction, the front-rear direction perpendicular to the X-axis direction on the horizontal plane (X-Y plane), and the up-down direction (vertical direction) perpendicular to both the X-axis direction and the Y-axis direction, respectively.

In the case of a battery pack, a plurality of secondary batteries (battery cells) is included within the battery pack, and then, venting occurs when the temperature of the internally disposed battery cells abnormally rises or the internal pressure of the battery cells rises above a certain level. Then, high-temperature gas and high-temperature spark containing electrode active materials, aluminum particles, and the like, are ejected to the outside of the battery cells.

In the case of a conventional battery pack, in order to suppress the temperature rise of the battery cells inside the pack, a water cooling method, an air cooling method, and the like, have been used. In the water cooling method, a pipe through which a cooling fluid flows is provided so as to cool the battery cells in a non-contact manner. In the air cooling method, the battery cells are cooled by using a fan, and the like.

Such a battery pack cooling method may cause a problem in that it is difficult to efficiently use the internal space of the battery pack because a pipe, a fan, and the like, have to be provided inside the pack.

In consideration of these factors, the present disclosure provides a technology for more efficiently cooling the battery cells in a battery pack. Furthermore, provided is a technology capable of effectively suppressing the thermal runaway of the battery cells when a thermal event, and the like, occurs inside the battery pack or extinguishing fire when the fire occurs.

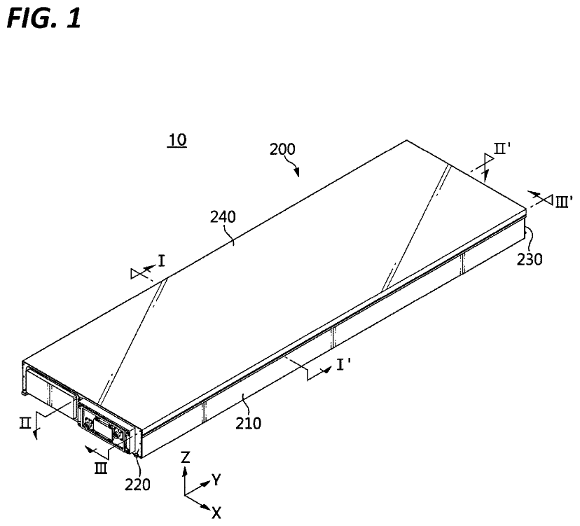

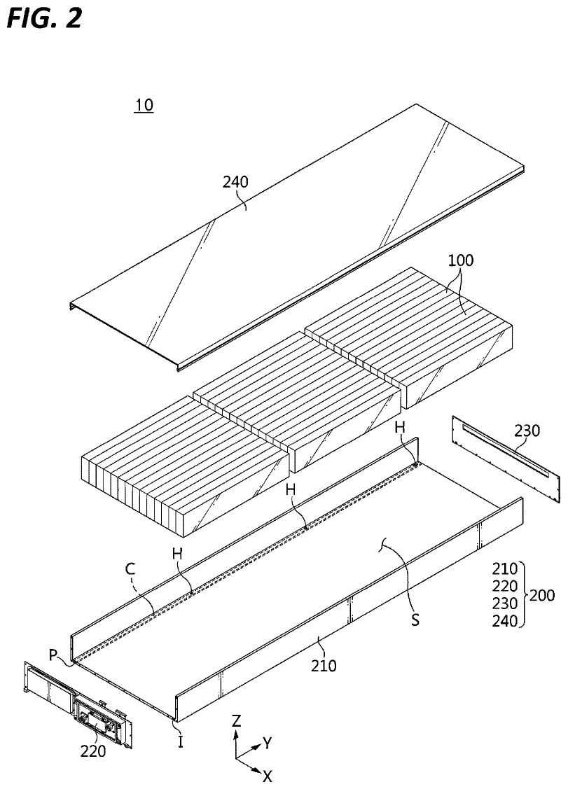

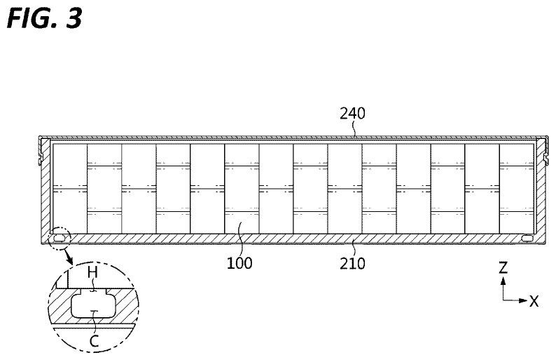

FIG. 1 is an overall perspective view of a battery pack according to one embodiment of the present disclosure, FIG. 2 is an exploded perspective view of the battery pack according to one embodiment of the present disclosure, and FIG. 3 is a cross-sectional view of the battery pack according to one embodiment of the present disclosure. For example, FIG. 3 may be a drawing illustrating the cross-section taken along I-I′ of FIG. 1.

Referring to FIGS. 1 to 3, a battery pack 10 according to one embodiment of the present disclosure includes a battery cell 100 and a pack case 200.

Referring to FIG. 2, a plurality of battery cells 100 may be included. Then, although not illustrated in the drawings, each of these battery cells 100 may include an electrode assembly, a cell case accommodating the electrode assembly, and an electrode lead that is connected to the electrode assembly and is taken out of the cell case to function as an electrode terminal. Here, the battery cells 100 may be electrically connected to each other inside the pack case 200.

For example, the battery cell 100 may be a pouch-type secondary battery. The cell case of such a pouch type secondary battery may be configured as a pouch form in which a metal layer made of aluminum is interposed between polymer layers.

As illustrated in FIG. 2, the battery cells 100 may be arranged side by side in the left-right direction (e.g., X-axis direction) while standing in the vertical direction (e.g., Z-axis direction).

The battery cells 100 may be stacked to form a plurality of cell arrays. As illustrated in FIG. 2, the cell arrays may be arranged side by side in the front-rear direction (e.g., Y-axis direction).

Meanwhile, the present disclosure is not limited by the specific type or shape of this battery cell 100, and various battery cells 100 known at the time of filing this invention may be employed to constitute the battery pack 10 of the present disclosure. For example, as in drawings, the present embodiment is targeted at an easily stackable pouch-type secondary battery with a high energy density, but it is natural that a cylindrical or prismatic secondary battery may be applied as the battery cell 100.

Also, although not illustrated in the drawings, the battery pack 10 according to one embodiment of the present disclosure may include a busbar assembly and/or a terminal electrically connected to the plurality of battery cells 100 housed therein.

The pack case 200 may be configured to accommodate the plurality of battery cells 100. The pack case 200 may provide an accommodation space S to accommodate the plurality of battery cells 100. The pack case 200 may be provided in a box shape including a plurality of frames.

The pack case 200 may be made of or may include a material capable of securing mechanical rigidity, such as plastic or metal (e.g., steel or SUS), to safely protect the battery cells 100, and the like, housed therein.

A cooling passage C may be formed in the pack case 200. The cooling passage C may refer to a passage configured to allow a cooling medium to flow. The cooling passage C may be formed in the internal space of the pack case 200. Here, the internal space of the pack case 200 may refer to a hollow space formed in any one of multiple frames constituting the pack case 200 as illustrated in FIG. 3.

Also, a communication hole H may be formed in the pack case 200. The communication hole H may be formed in the frame of the pack case 200 in which the cooling passage C is formed. The communication hole H may be configured in the form of a hole, which is formed through the inner surface of the frame of the pack case 200. Through the configuration of the communication hole H, the cooling passage C may communicate with the accommodation space S where the battery cells 100 are accommodated. At least one communication hole H may be provided per pack case 200.

Accordingly, the cooling medium inside the cooling passage C may be discharged through the communication hole H into the accommodation space S where the battery cells 100 are accommodated, so that the accommodation space S of the pack case 200 may be filled with the cooling medium. In this manner, in the battery pack 10 according to one embodiment of the present disclosure, the immersion cooling method may be used to cool the battery cells 100.

For example, in the battery pack 10 according to one embodiment of the present disclosure, when a problem occurs due to overheating, and the like, of the battery cells 100, the cooling medium within the cooling passage C may be discharged through the communication hole H into the accommodation space S where the battery cells 100 are accommodated. As a result, the cooling medium is placed in an impregnation state in which the cooling medium is in direct contact with the battery cells 100 within the battery pack 10, thereby uniformly cooling the entire battery cells 100.

According to one embodiment, the cooling medium may be made of a non-conductive fluid. For example, as for the cooling medium, an insulating oil, a silicone oil, a fluorine-based fluid, and the like, may be provided.

According to the above embodiment of the present disclosure, although the accommodation space S of the pack case 200 is filled with the cooling medium, the cooling medium may come in direct contact with the battery cells 100 without causing electrical damage to the battery cells 100, thereby more efficiently cooling the battery cells 100. This may improve the cooling performance of the battery pack 10.

According to the above embodiment of the present disclosure, since other components for cooling, such as a pipe or a fan, are unnecessary, it is possible to efficiently use the internal space of the battery pack 10. Therefore, the energy efficiency of the battery pack 10 may be improved.

According to the above embodiment of the present disclosure, in an abnormal situation such as overheating of the battery cells 100, the cooling medium is discharged into the accommodation space S through the communication hole H, thereby quickly responding to thermal runaway of the battery cells 100. Thus, the safety and reliability of the battery pack 10 may be guaranteed.

Furthermore, the accommodation space S is filled with the cooling medium so that the cooling medium may come in direct contact with all battery cells 100 within the battery pack 10. Thus, a temperature difference between the battery cells 100 may be minimized. Accordingly, the overall performance of the battery pack 10 may be improved.

Meanwhile, referring to, for example, FIG. 2, the pack case 200 according to one embodiment of the present disclosure may include a bottom plate 210, a front plate 220 and a rear plate 230.

In the configuration of the bottom plate 210, the plurality of battery cells 100 may be seated in the accommodation space S. The bottom plate 210 may include a flat-bottomed upper surface on which the plurality of battery cells 100 may be stably seated.

The bottom plate 210 may form the bottom surface of the pack case 200.

Also, the bottom plate 210 may form the left surface and the right surface of the pack case 200. For example, the bottom surface, the left surface, and the right surface of the pack case 200 may be integrally formed. The bottom plate 210 may be configured to cover the bottom surface, the left surface, and the right surface of the plurality of battery cells 100.

The front plate 220 is located at the front (e.g., −Y axis direction) end of the bottom plate 210 and may be configured to cover the front surfaces of the battery cells 100.

The rear plate 230 is located at the rear (e.g., +Y axis direction) end, and may be configured to cover the rear surfaces of the battery cells 100.

The pack case 200 may further include a top plate 240. The top plate 240 may be configured to cover the top side of the plurality of battery cells 100. To this end, the top plate 240 may be coupled to the bottom plate 210 and may be provided to form the top surface of the pack case 200.

Meanwhile, such a shape of the pack case 200 is merely an example, and apart from this, the pack case 200 may be formed in other various shapes.

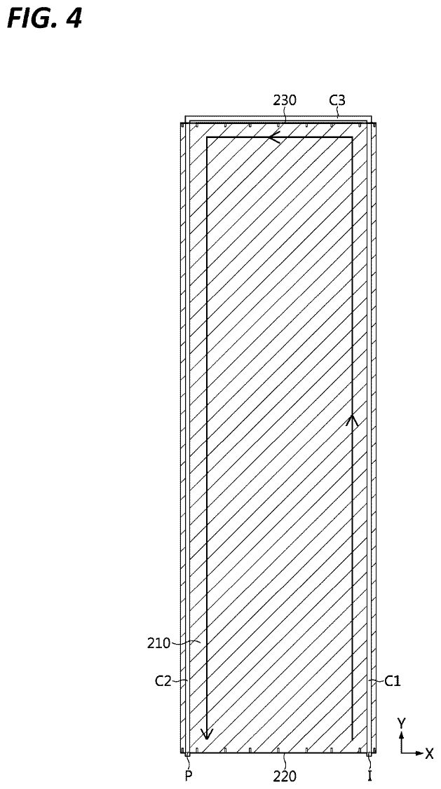

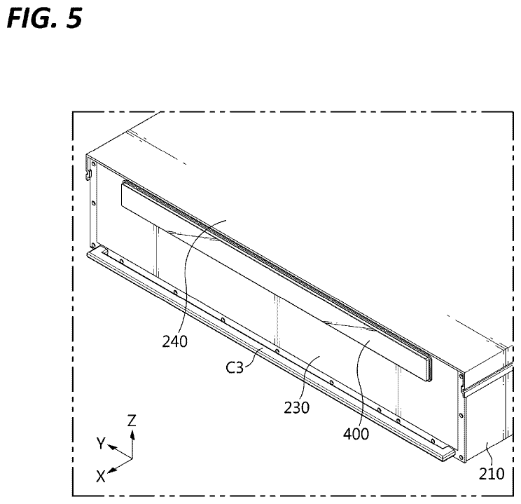

FIG. 4 is a cross-sectional view of the battery pack according to one embodiment of the present disclosure. For example, FIG. 4 may be a drawing illustrating a cross-section taken along II-II′ of FIG. 1. Also, FIG. 5 is a rear perspective view of the battery pack according to one embodiment of the present disclosure.

Referring to FIG. 4, the cooling passage C may be formed in a hollow shape at least partially in the inner space of the pack case 200. For example, the cooling passage C may be provided in a hollow shape within any one of the frames of the pack case 200. Accordingly, the cooling passage C and the accommodation space S may be configured to be completely separated. For example, as in the embodiment illustrated in the drawings, the cooling passage C may be formed in the inner space of the bottom plate 210.

The cooling passage C may be extrusion-molded and may be formed integrally with the bottom plate 210. As the bottom plate 210 is extrusion-molded, the cooling passage C may be formed to extend in a straight line at least partially along the extrusion direction (e.g., the longitudinal direction of the bottom plate 210).

According to the above embodiment of the present disclosure, since the cooling passage C is integrally provided in the bottom plate 210, a process of manufacturing a separate pipe and inserting the pipe into the bottom plate 210 may be omitted. Accordingly, productivity may be improved when the battery pack 10 is manufactured.

Also, according to the above embodiment of the present disclosure, since a defect between the cooling passage C and the bottom plate 210 may be minimized, leakage of the cooling medium may be prevented.

According to one embodiment, the cooling passage C may be formed along the periphery of the bottom plate 210. For example, as in the embodiment illustrated in FIG. 4, the cooling passage C may be formed in a U-shape. For example, the cooling passage C may be provided along the left, right and rear edges of the bottom plate 210.

A predetermined space may be provided between the battery cells 100 and the side wall of the bottom plate 210. Then, as in the above embodiment of the present disclosure, as the cooling passage C is formed along the periphery of the bottom surface of the bottom plate 210, the cooling medium may be supplied to the predetermined space, thereby more easily filling the accommodation space S.

Also, according to the above embodiment of the present disclosure, the cooling passage C has a simpler structure or shape than the conventional art, and the cooling medium may be uniformly supplied to the accommodation space S of the pack case 200 while flowing along the periphery of the bottom plate 210.

According to one embodiment, the cooling passage C may include a first passage C1 and a second passage C2. The first passage C1 and the second passage C2 may be formed on both sides of the pack case 200, respectively. The first passage C1 and the second passage C2 may be formed on both sides of the bottom plate 210 in the left-right direction, respectively.

Since the bottom plate 210 is manufactured by an extrusion method, the first passage C1 and the second passage C2 may be formed to extend along the longitudinal direction of the bottom plate 210.

Accordingly, the cooling medium may flow along the first passage C1 and the second passage C2 within the pack case 200.

Also, the cooling passage C may include a connecting passage C3. According to one embodiment, the connecting passage C3 may be provided outside the pack case 200 along the rear edge of the pack case 200. This connecting passage C3 may be configured to connect the first passage C1 to the second passage C2.

As the bottom plate 210 is extrusion-molded, holes may be formed at both longitudinal ends of each of the first passage C1 and the second passage C2. Then, the connecting passage C3 may be configured to connect these ends of the first passage C1 and the second passage C2, outside the pack case 200.

For example, as in the embodiment illustrated in FIG. 4 and FIG. 5, the connecting passage C3 may be provided on the rear plate 230 side and may be configured to connect the rear end of the first passage C1 to the rear end of the second passage C2.

Here, the connecting passage C3 may be configured to extend in a direction perpendicular to the direction in which the first passage C1 and the second passage C2 extend. For example, the connecting passage C3 may be configured to extend along the periphery of the rear plate 230.

According to the above embodiment of the present disclosure, the cooling passage C may allow the cooling medium to be supplied to the accommodation space S without occupying the volume of the accommodation space S of the pack case 200.

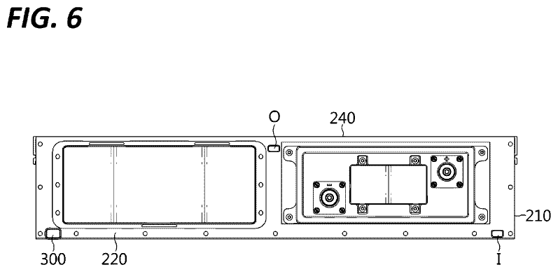

FIG. 6 is a view illustrating a front view of the battery pack 10 according to one embodiment of the present disclosure.

Here, the pack case 200 may include an inlet port I and a discharge port O. The inlet port I may be configured to allow the cooling medium to flow into the cooling passage C, and the discharge port O may be configured to allow the cooling medium to be discharged to the outside of the pack case 200. A hose through which the cooling medium flows may be connected to the inlet port I and the discharge port O.

The inlet port I may be provided at one end of the cooling passage C. For example, as described above, both longitudinal ends of the first passage C1 and the second passage C2 may be configured as a form of holes. Here, the inlet port I may be provided at the front end of the first passage C1. For example, the rear ends of the first passage C1 and the second passage C2 may be connected by the connecting passage C3, and the front end of the first passage C1 may be configured as the inlet port I to which an external hose is connected.

The discharge port O may be provided outside the cooling passage C. The discharge port O may be provided on one side surface of the pack case 200. For example, as in the embodiment illustrated in FIG. 6, the discharge port O may be provided on the front plate 220. The discharge port O may be configured as a form of a hole, which is formed through a portion of the pack case 200. In this configuration, through the discharge port O, the cooling medium having filled the accommodation space S may be discharged to the outside of the pack case 200.

The height at which the discharge port O is provided may be different from the height at which the inlet port I is provided. For example, the inlet port I may be provided on the bottom surface of the pack case 200, and the discharge port O may be provided on the top side of the pack case 200. Through this configuration, when the thermal runaway occurs inside the pack case 200, the cooling medium may be maintained in an amount equal to or greater than a predetermined level within the accommodation space S.

Meanwhile, the inlet port I and the discharge port O may be provided on the same side surface of the pack case 200. For example, as in the embodiment illustrated in FIG. 6, both the inlet port I and the discharge port O may be provided on the front plate 220.

According to the above embodiment of the present disclosure, since both the inlet port I and the discharge port O are provided on the front side of the battery pack 10, the maintenance of an external component connected to a coolant exchange unit (CEU), such as a hose, provided outside the pack case 200 may be easy.

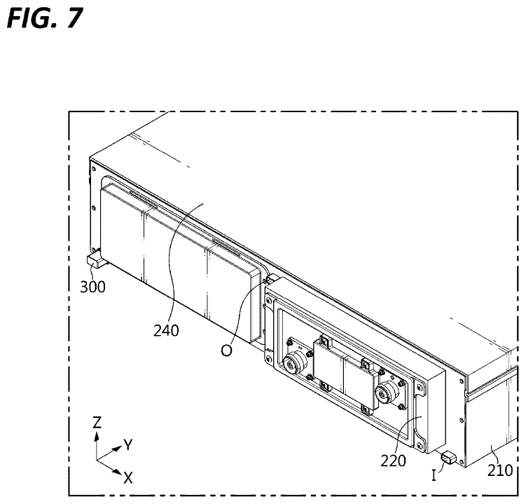

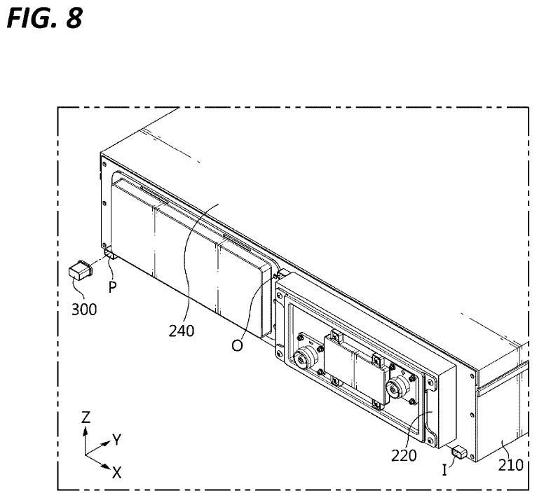

FIG. 7 is a front perspective view of the battery pack 10 according to one embodiment of the present disclosure, and FIG. 8 is a front perspective view of the battery pack 10 according to one embodiment of the present disclosure, in which a portion of the configuration is disassembled.

One end of the cooling passage C may be configured to be opened, and the other end of the cooling passage C may be configured to be closed. Here, one end of the cooling passage C may mean the inlet port I provided at the front end of the first passage C1. Also, the other end of the cooling passage C may mean a closed port P provided at the front end of the second passage C2. For example, one end of the cooling passage C may be the inlet port I, and the other end of the cooling passage C may be the closed port P.

The closed port P, for example, the front end of the second passage C2, may be configured to be closed. For example, referring to FIG. 7 and FIG. 8, the battery pack 10 according to one embodiment of the present disclosure may further include a closing member 300 configured to cover the closed port P. The closing member 300 may be configured to cover the front end of the second passage C2. The closing member 300 may be made of a flexible material such as rubber or silicone. Through the configuration of the closing member 300, a close state of the closed port P may be maintained.

According to the above embodiment of the present disclosure, since one end of the cooling passage C is configured to be closed, the cooling medium within the cooling passage C may be prevented from escaping to the outside of the pack case 200. Therefore, the cooling medium may flow inside the cooling passage C with a constant directionality.

For example, referring to the arrow illustrated in FIG. 4, in this configuration, the cooling medium introduced into the first passage C1 via the inlet port I may be allowed to flow through the second passage C2 via the connecting passage C3. Accordingly, the cooling medium flows along the periphery of the bottom plate 210, and may be uniformly supplied to the accommodation space S of the pack case 200 as necessary.

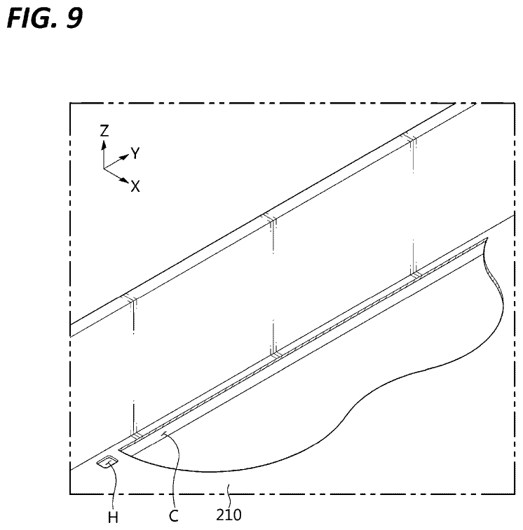

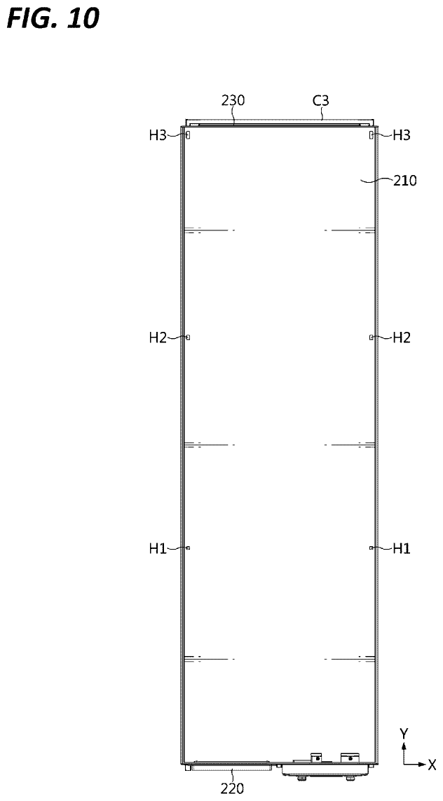

FIG. 9 is a perspective view of a portion of the battery pack 10 according to one embodiment of the present disclosure, in an enlarged scale, and FIG. 10 is a top view of the interior of the battery pack 10 according to one embodiment of the present disclosure.

Referring to FIG. 9, the communication hole H may be formed in the inner surface of the bottom surface of the bottom plate 210. The communication hole H may be provided above the cooling passage C. The size or shape of the communication hole H may be configured differently depending on the type of the cooling medium.

Referring to FIG. 10, a plurality of communication holes H1, H2, and H3 may be provided. Also, the communication holes H1, H2, and H3 may be disposed along a direction in which the cooling passage C extends. For example, the communication holes H1, H2, and H3 may be provided along the edges of the bottom plate 210.

The plurality of communication holes H1, H2, and H3 may be provided in each of the first passage C1 and the second passage C2. The positions of the communication holes H1, H2, and H3 formed in the first passage C1 and the second passage C2 may be configured to be symmetrical to each other as exemplified in the drawing.

According to the above embodiment of the present disclosure, the cooling medium may be supplied to the accommodation space S of the pack case 200 through the communication holes H1, H2, and H3 provided along the periphery of the bottom plate 210.

According to one embodiment of the present disclosure, the cross-sectional areas of the communication holes H1, H2, and H3 may be at least partially differentially configured in order to equalize the flow rates of the cooling medium supplied to the accommodation space S via the communication holes H1, H2, and H3.

The flow rate of the cooling medium flowing into each of the communication holes H1, H2, and H3 is proportional to the product of the flow velocity of the cooling medium at the corresponding location and the cross-sectional area of the corresponding communication hole H1, H2, and H3. Depending on the respective locations of the communication holes H1, H2, and H3 within the battery pack 10, the flow velocities of the cooling medium may differ at the respective communication holes H1, H3, and H3. In such a case, as in the above embodiment of the present disclosure, the respective cross-sectional areas of the communication holes H1, H2, and H3 may be differently configured according to the locations, so that the flow rates of the cooling medium may be made equal regardless of the locations within the battery pack 10.

According to the above embodiment of the present disclosure, by equalizing the flow rates of the cooling medium supplied to the accommodation space S, a temperature difference between the battery cells 100 may be minimized regardless of the locations of the battery cells 100 within the battery pack 10. Accordingly, the lifespan of the battery pack 10 may be extended, and the performance of the battery pack 10 may be improved to the maximum extent.

According to one embodiment, the respective cross-sectional areas of the communication holes H1, H2, and H3 may be differentially configured along the extension direction of the cooling passage C. For example, as the distance from the inlet port I of the cooling passage C increases, the flow velocity of the cooling medium flowing into the accommodation space S is decreased, and then the respective flow rates of the communication holes H1, H2, and H3 may be gradually decreased. Accordingly, as in the embodiment illustrated in FIG. 10, as the distance from the inlet port I increases, the respective cross-sectional areas of the communication holes H1, H2, and H3 may be increased (H1<H2<H3). For example, the inlet port I is provided on one side of the pack case 200, for example, the front side, and the respective cross-sectional areas of the communication holes H1, H2, and H3 may be gradually increased toward the rear side of the pack case 200.

As in one embodiment of the present disclosure, since the respective cross-sectional areas of the communication holes H1, H2, and H3 are increased as the distance from the inlet port I increases, it is possible to equalize the flow rates of the cooling medium flowing into the accommodation space S regardless of the respective locations of the battery cells 100. Accordingly, a temperature difference between the battery cells 100 may be minimized, thereby increasing the efficiency of the battery pack 10.

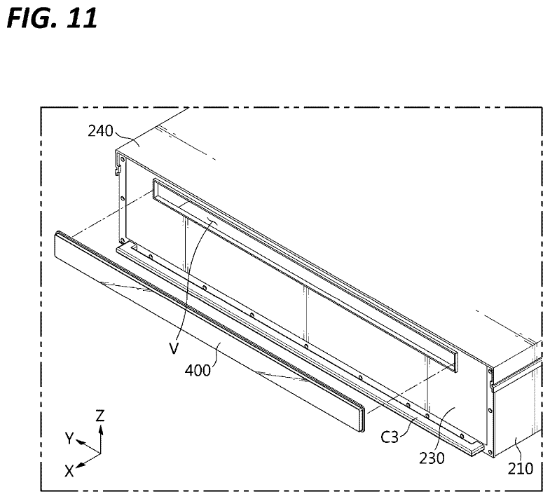

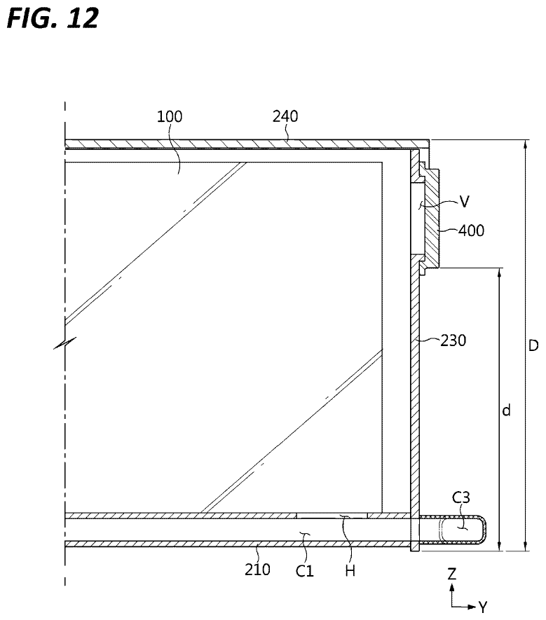

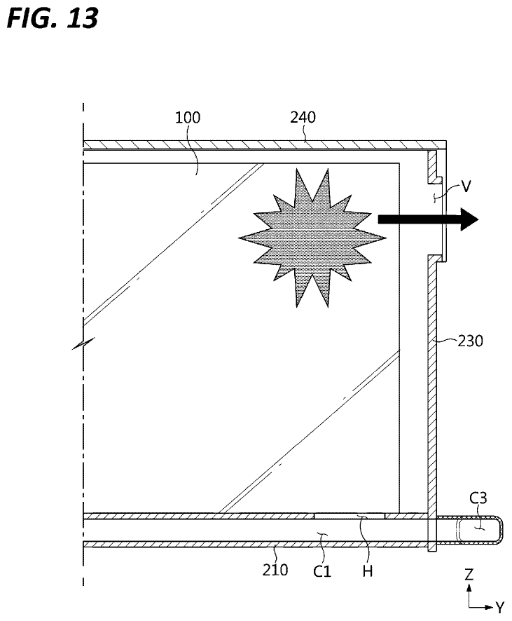

FIG. 11 is a rear perspective view of the battery pack 10 according to one embodiment of the present disclosure, in which a portion of the configuration is disassembled. Also, FIG. 12 is a cross-sectional view of the battery pack 10 according to one embodiment of the present disclosure. For example, FIG. 12 may be a drawing illustrating a portion of the rear side of a cross-section taken along III-III′ of FIG. 1. Then, FIG. 13 is a cross-sectional view in a case where a thermal event has occurred in the battery pack 10 according to one embodiment of the present disclosure.

Meanwhile, referring to FIG. 11 to FIG. 13, the pack case 200 may include a venting portion V. The venting portion V may be configured to discharge gas generated from the battery cells 100 accommodated inside the pack case 200, to the outside of the pack case 200. The venting portion V may be formed such that the inside and outside of the pack case 200 may communicate with each other.

According to one embodiment, the venting portion V may be provided in the form of a hole. For example, the venting portion V may be provided in the form of a hole formed in the pack case 200, and may be configured such that the inside and outside of the pack case 200 may communicate with each other. According to one embodiment, the venting portion V may be provided in a rectangular shape. The position, the shape, the structure, and the like, of the venting portion V provided in the pack case 200 may be differently designed according to the internal structure, and the like, of the pack case 200.

According to the above embodiment of the present disclosure, heat and pressure of venting gas or flame generated when thermal runaway of the battery cells 100 occurs inside the pack case 200 may be discharged to the outside of the pack case 200 via the venting portion V. Accordingly, venting gas may be smoothly discharged to the outside of the pack case. Moreover, heat accumulation inside the pack case 200 may be prevented or suppressed, and thus, other battery cells 100 may not be thermally damaged as much as possible.

According to the above embodiment of the present disclosure, not only venting gas or flame, but also gases generated due to vaporization of the cooling medium may be discharged to the outside of the pack case 200 via the venting portion V.

The venting portion V may be provided on one side surface of the pack case 200. The venting portion V may be located on at least a part of several frames forming the pack case 200. For example, referring to those illustrated in FIG. 11 to FIG. 13, the venting portion V may be provided on the rear plate 230.

According to the above embodiment of the present disclosure, when the venting portion V is provided on the rear side of the battery pack 10, when venting gas, and the like, are discharged via the venting portion V, a user, and the like, present in front of the battery pack 10 may be protected.

According to one embodiment, the venting portion V may be provided on the upper side of the rear plate 230. For example, in this configuration, the height d at which the venting portion V is provided on the pack case 200 may be approximately 70% or more of the height D of the pack case 200. According to the above embodiment of the present disclosure, leakage of the cooling medium equal to or greater than a predetermined amount through the venting portion V may be suppressed. Therefore, when the thermal runaway of the battery cells 100 occurs, the cooling medium may be maintained in an amount equal to or greater than a predetermined level in the accommodation space S, thereby cooling the battery cells 100.

The battery pack 10 according to one embodiment of the present disclosure includes a cover member 400 configured to cover the venting portion V. The cover member 400 may be provided on one side surface of the pack case 200. The cover member 400 may be attached to the pack case 200 and may be configured to cover the entire venting portion V.

According to the above embodiment of the present disclosure, since the cover member 400 is configured to cover the venting portion V, foreign substances such as dust may be blocked from flowing into the pack case 200 via the venting portion V. As a result, the dustproof function of the battery pack 10 may be secured, thereby ensuring the safety and reliability of the battery pack 10.

According to the above embodiment of the present disclosure, during manufacturing of the battery pack 10, the cover member 400 only needs to be attached from the outside after the pack case 200 is completely assembled. Thus, the assembly efficiency may be improved.

The cover member 400 may be configured to open and close the venting portion V. For example, referring to FIG. 12 and FIG. 13, in this configuration, under normal conditions, a state where the cover member 400 is attached to the pack case 200 may be maintained to cover the venting portion V (FIG. 12) whereas under certain circumstances, for example, when a thermal event has occurred, the cover member 400 may be opened (FIG. 13).

For example, the cover member 400 may be configured to open the venting portion V when the internal pressure of the pack case 200 has reached a specific pressure. When the internal pressure of the pack case 200 has reached a specific pressure, for example, a state where the cover member 400 is attached to the pack case 200 may be released and then the cover member 400 may be detached, or a portion of the cover member 400 may be ruptured and opened due to gas pressure.

According to the above embodiment of the present disclosure, when an abnormal situation has occurred in the battery pack 10, the cover member 400 is opened, and thus gas generated from the battery cells 100 and/or gas generated due to vaporization of the cooling medium may be smoothly discharged to the outside of the pack case 200 via an exposed portion of the venting portion V (e.g., see the thick arrow illustrated in FIG. 13). Thus, when an abnormal situation has occurred in the battery cells 100, the pressure inside the pack case 200 may be prevented or suppressed from rising, thereby preventing additional chain ignition in other battery cells 100. With such a configuration, according to the above aspect of the present disclosure, the safety and reliability of the battery pack 10 may be guaranteed.

According to one embodiment, the cover member 400 may be made of a material having heat-resistant performance. The battery pack 10 may generate heat during a normal operation through repeated charging/discharging. Also, a device equipped with the battery pack 10, for example, an energy storage system (ESS), may be placed in a situation where it is more exposed to heat in high-temperature conditions such as summer.

According to the above embodiment of the present disclosure, in the normal state of the battery pack 10, it is possible to stably maintain a state where the cover member 400 covers the venting portion V. Also, even when a high-temperature gas is generated in some of the battery cells 100 included in the battery pack 10, the cover member 400 may not be opened in a case where no thermal event has occurred in the battery pack 10 or normal use is possible.

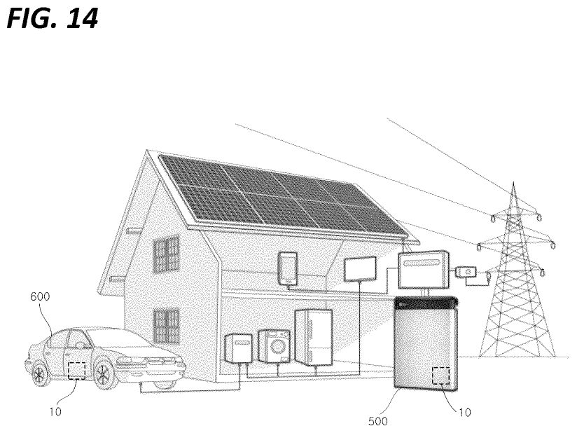

Referring to FIG. 14, an energy storage device 500 according to one embodiment of the present disclosure may include the battery pack 10 according to the present disclosure. The energy storage device 500 may include, for example, a battery container including a plurality of battery packs 10 and a container housing having a configuration within which the battery packs 10 are stackable. In addition, the present disclosure may include various battery systems including the battery pack 10 according to the present disclosure. For example, a battery charging system, a battery exchange system, a battery repair system, and the like, according to the present disclosure may be battery systems according to the present disclosure. The energy storage device 500 may include one or more of these battery systems.

Also, a vehicle 600 according to one embodiment of the present disclosure may include the battery pack 10 according to the present disclosure. The vehicle 600 according to the present disclosure may be, for example, an electric vehicle, a hybrid vehicle or a plug-in hybrid vehicle. The vehicle 600 may include a four-wheeled vehicle and a two-wheeled vehicle. The vehicle 600 may operate when power is supplied from the battery pack 10 according to one embodiment of the present disclosure.

While the present disclosure has been described above with reference to several embodiments and drawings, the present disclosure is not limited thereto, and various changes and modifications can be made by a person ordinarily skilled in the art to which the present disclosure pertains without departing from the technical spirit of the present disclosure and the equivalent scope of the claims to be described below.

What is claimed is:

1. A battery pack comprising:
a plurality of battery cells; and
a pack case having an accommodation space in which the plurality of battery cells are accommodated and including: a cooling passage configured to allow a cooling medium to flow and at least one communication hole configured to allow the cooling passage to communicate with the accommodation space.

2. The battery pack according to claim 1, wherein the cooling passage is formed in a hollow shape at least partially in the inner space of the pack case.

3. The battery pack according to claim 1, wherein the pack case includes a bottom plate having a configuration in which the plurality of battery cells is seated, and having an inner space in which the cooling passage is formed.

4. The battery pack according to claim 3, wherein the cooling passage is formed along the periphery of the bottom plate.

5. The battery pack according to claim 1, wherein the cooling passage includes a first passage and a second passage formed on both sides of the pack case, respectively.

6. The battery pack according to claim 5, wherein the cooling passage includes a connecting passage that is provided outside the pack case and is configured to connect the first passage to the second passage.

7. The battery pack according to claim 1, wherein the pack case includes:
an inlet port configured to allow the cooling medium to flow into the cooling passage, and
a discharge port configured to allow the cooling medium to be discharged to the outside of the pack case.

8. The battery pack according to claim 7, wherein the inlet port and the discharge port are provided on the same side surface of the pack case.

9. The battery pack according to claim 1, wherein one end of the cooling passage is configured to be opened, and
the other end of the cooling passage is configured to be closed.

10. The battery pack according to claim 1, wherein a plurality of communication holes is provided and disposed along a direction in which the cooling passage extends.

11. The battery pack according to claim 10, wherein the cross-sectional areas of the communication holes are at least partially differentially configured.

12. The battery pack according to claim 1, wherein the pack case includes a venting portion on one side surface, the venting portion being configured to discharge venting gas, generated from the battery cells, to the outside.

13. The battery pack according to claim 12, further comprising:
a cover member that covers the venting portion, the cover member being configured to open the venting portion when the internal pressure of the pack case has reached a specific pressure.

14. An energy storage system comprising the battery pack according to claim 1.

15. A vehicle comprising the battery pack according to claim 1.

16. A pack case comprising:
a bottom plate having an accommodation space in which a plurality of battery cells is accommodated; and
a top plate coupled to the bottom plate and provided to cover the top side of the plurality of battery cells accommodated in the accommodation space,
wherein, in the bottom plate, a cooling passage is formed such that a cooling medium is allowed to flow along the periphery of a bottom surface.

17. The pack case according to claim 16, wherein, in the cooling passage, at least one communication hole is formed, the communication hole being configured to allow the cooling medium to be injected into the accommodation space from the cooling passage.

18. The pack case according to claim 17, wherein a plurality of communication holes is formed in the cooling passage, and the respective cross-sectional areas of the communication holes are at least partially differentially configured.
